(19) United States
(12) Patent Application Publication
(10) Pub. No.: US 2010/0326536 A1
(43) Pub. Date: Dec. 30, 2010

(54) DIRECTION CONTROL VALVE FOR SHOWER IRRIGATING APPLICATIONS

(75) Inventor: Simon Siu Man Nan, Ontario (CA)

Correspondence Address: POLSINELLI SHUGHART PC, 700 W. 47TH STREET, SUITE 1000, KANSAS CITY, MO, 64112-1802, US

(73) Assignee: NANMA MANUFACTURING CO., LTD., Chai Wan (CN)

(21) Appl. No.: 12/875,712

(22) Filed: Sep. 3, 2010

Related U.S. Application Data
(62) Division of application No. 11/710,793, filed on Feb. 26, 2007.

(51) Int. Cl. F16K 17/14

(52) U.S. Cl. 137/14; 137/68.11

(57) ABSTRACT

Embodiments of the presently described technology provide a direction control valve including first and second orifices and a pressure release mechanism. The first and second orifices provide a path of fluid flow through the valve from an inlet port to a first outlet port. The pressure release mechanism is configured to reduce pressure in the valve through a second outlet port. Embodiments of the presently described technology also provide a direction control valve including first and second fluid communication paths. The first fluid communication path is defined by an inlet port, first and second orifices, and a first outlet port. The second fluid communication path is defined by the inlet port, the first orifice, a pressure release mechanism, and a second outlet port. The second fluid communication path of the valve does not exist until an internal pressure of the valve exceeds a predetermined threshold.

### CROSS-REFERENCE TO RELATED APPLICATIONS

This application is a divisional application and claims the benefit of U.S. patent application entitled “Direction Control Valve for Shower Irrigating Applications”, Ser. No. 11/710,793, filed Feb. 26, 2007, the entire contents of which are herein incorporated by reference.

### BACKGROUND OF THE INVENTION

The presently described invention generally relates to hydraulic valves. More specifically, embodiments of the presently described technology provide an improved valve for safely controlling the pressure in and direction of fluid flow through the valve.

In applications where fluid is diverted or directed from a source, pressure can build in the device or apparatus used to direct the fluid. At a certain point, the pressure internal to the device or apparatus can reach a level at which the device fails. When the device fails, the device can explode and injure persons and damage property in the vicinity of the device.

For example, in personal applications such as in a shower, a user may wish to divert water directed from a sink or showerhead to another place or to a device connected to the showerhead. Such applications can include the diversion of water pressure for the internal irrigating of body organs, body massaging or sexual stimulation. One manner to achieve these and other applications is to attach a device to a showerhead, where the device is powered and operated by the water pressure from the showerhead.

In order to connect the showerhead to the device, a direction control valve may be required. Such a valve can distribute the water between the showerhead and other water-driven functional units or devices. Standard showerheads typically do not include a direction control valve. Therefore, in order to connect a water-driven device to a showerhead, a water flow direction control valve typically must be provided.

The types of direction control valves currently available have a number of limitations. For example, many existing valves do not have sufficient safeguards to protect users and surrounding property from explosions that can result due to a build-up of pressure in the valve. In addition, currently available valves are not easily installed, removed and operated by users. These valves also typically have very ineffective sealing capabilities. That is, currently available flow-direction valves generally leak water during their operation. Currently available valves also tend to be manufactured at a substantial cost.

Thus, a need exists for an improved direction control valve. Such a valve should be safer than existing valves by preventing explosions from a build-up of water or other fluid pressure. In addition, such a valve should be easily installed, removed and operated by the typical user, have improved sealing to prevent leakage of the fluid being diverted and/or be manufactured at a reduced cost when compared to existing direction control valves.

### BRIEF SUMMARY OF THE INVENTION

Embodiments of the presently described technology provide a direction control valve including first and second orifices and a pressure release mechanism. The first and second orifices provide a path of fluid flow through the valve from an inlet port to a first outlet port. The pressure release mechanism is configured to reduce pressure in the valve through a second outlet port.

Embodiments of the presently described technology also provide a direction control valve including a first fluid communication path and a second fluid communication path. The first fluid communication path is defined by an inlet port, first and second orifices inside the valve, and a first outlet port of the valve. The second fluid communication path is defined by the inlet port, the first orifice, a pressure release mechanism in the valve, and a second outlet port of the valve. The second fluid communication path of the valve does not exist until an internal pressure of the valve exceeds a predetermined threshold.

Embodiments of the presently described technology also provide a method for releasing pressure in a direction control valve. The method includes providing a path of fluid flow through the valve from an inlet port to a first outlet port via first and second orifices and reducing pressure in the valve through a second outlet port by at least one of rupturing a thin-walled portion of the valve and moving a portion of a wall in the valve.

### BRIEF DESCRIPTION OF THE SEVERAL VIEWS OF THE DRAWINGS

FIG. 1 illustrates a perspective view of a direction control valve in accordance with an embodiment of the presently described technology;

FIG. 2 illustrates a perspective view of an irrigating device capable of being connected to an outlet port of a direction control valve in accordance with an embodiment of the presently described technology;

FIG. 3 illustrates an exploded view of a pressure relief mechanism of a direction control valve in accordance with an embodiment of the presently described technology;

FIG. 4 illustrates a perspective view of a turning knob capable of being used to operate a direction control valve in accordance with an embodiment of the presently described technology;

FIG. 5 illustrates a sectional view and a top view of a direction control valve in accordance with an embodiment of the presently described technology;

FIG. 6 illustrates an exploded view of internal components of a direction control valve in accordance with another embodiment of the presently described technology;

FIG. 7 illustrates second and third sectional views of a direction control valve in accordance with another embodiment of the presently described technology;

FIG. 8 illustrates a flowchart for a method for providing a pressure release mechanism in a direction control valve in accordance with an embodiment of the presently described technology;

FIG. 9 illustrates a perspective view of the knob in accordance with an embodiment of the presently described technology; and

FIG. 10 illustrates a perspective view of the knob in accordance with an embodiment of the presently described technology.

The foregoing summary, as well as the following detailed description of certain embodiments of the presently described technology, will be better understood when read in conjunction with the appended drawings. For the purpose of illustrating the presently described technology, certain embodiments are shown in the drawings. It should be understood, however, that the presently described technology is not limited to the arrangements and instrumentality shown in the attached drawings.

### DETAILED DESCRIPTION OF THE INVENTION

In accordance with embodiments of the presently described technology, a hydraulic direction control valve is provided for directing the flow of fluid from an inlet port to various outlet ports. The valve can comprise a main body with an inlet port and two outlet ports, a rotational spool, a turning knob attached to the rotational spool, and a cover to retain the rotational spool inside the main body.

Embodiments of the presently described valve can include a pressure relief apparatus included in the rotational spool. The pressure relief apparatus can include a destructive or non-destructive mechanism. That is, the pressure relief apparatus can be destroyed (and no longer operable) once fluid pressure in the valve is relieved (the destructive mechanism) or not destroyed and capable of being used again once fluid pressure in the valve is relieved (the non-destructive mechanism).

Embodiments of the presently described valve can also include an improved seal. For example, at the exit of one or more orifices of the valve a sealing element can be disposed between an outer surface of the rotational spool and a wall of the chamber in the main body. In another example, sealing elements can be provided between a valve cover and the main body and between the cover and the rotational spool. In another example, sealing elements can be provided between the outer surface of the rotational spool and the wall of the chamber in the main body where the rotational spool is located.

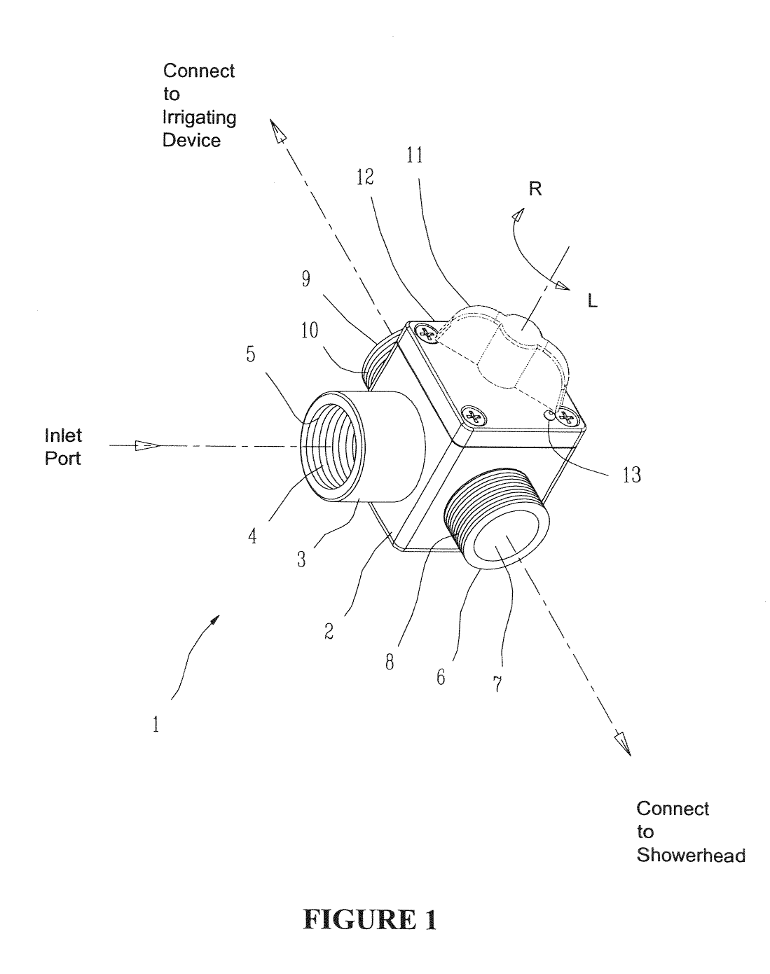

FIG. 1 illustrates a perspective view of a direction control valve 1 in accordance with embodiments of the presently described technology. Valve 1 includes a main valve body 2, an inlet port 3, a first outlet port 6, a second outlet port 9, a turning knob 11 and a body cover or lid 12.

Main body 2 can be comprised of any material capable of directing the flow of fluid entering body 2 from inlet port 3 to first and/or second outlet ports 6, 9. For example, main body 2 can comprise a metallic or plastic material. In the case of plastic materials, the main structure of valve 1 is thereby manufactured at a substantially reduced cost.

Inlet port 3 defines and provides an opening 4 into main body 2. In an embodiment, opening 4 includes an internal screw thread 5. In another embodiment, opening 4 includes an external screw thread 5 (similar to internal screw thread 5 but located on the exterior of opening 4 as shown with respect to first and second outlet ports 6, 9 in FIG. 1).

First outlet port 6 defines and provides another opening 7 into main body 2. In an embodiment, opening 7 includes an external screw thread 8. In another embodiment, opening 7 includes an internal screw thread 8 (similar to external screw thread 8 but located on the interior of opening 7 as shown with respect to inlet port 3 in FIG. 1).

Second outlet port 9 defines and provides another opening (not shown in FIG. 1) into main body 2. The opening provided by second outlet port 9 is similar, if not identical, to opening 7 provided by first outlet port 6. In an embodiment, the opening provided by second outlet port 9 includes an external screw thread 10. In another embodiment, the opening provided by second outlet port 9 includes an internal screw thread 10 (similar to external screw thread 8 but located on the opening provided by second outlet port 9 as shown with respect to inlet port 3 in FIG. 1).

Turning knob 11 is connected to a shaft 29 inside main body 2 and can be turned or rotated about a center axis defined by and common to the center of knob 11 and main body 2. Shaft 29 can be extended through a center hole 35 on body cover 12. Knob 11 can then be placed on shaft 29.

As illustrated in FIG. 1, turning knob 11 is capable of being turned or rotated in one or more of directions R and L (R defining an approximately clockwise rotation with respect to main body 2 and L defining an approximately counter-clockwise rotation with respect to main body 2). As described in more detail below, knob 11 is capable of being turned by a user in order to control the outflow direction of fluid entering valve 1 via inlet port 3. For example, by turning knob 11 in one direction, fluid entering valve 1 via inlet port 3 exits first outlet port 6. By turning knob 11 in another direction, fluid entering valve 1 via inlet port 3 is instead directed towards and exits valve 1 via second outlet port 9.

In an embodiment, body cover or lid 12 is connected to main body 2 between knob 11 and body 2. Cover 12 can be connected to main body 2 through any of several techniques. For example, cover 12 can be connected using one or more screws, nails, clamps or adhesives. In another example, cover 12 can be connected through a snap-fit connection between cover 12 and body 2.

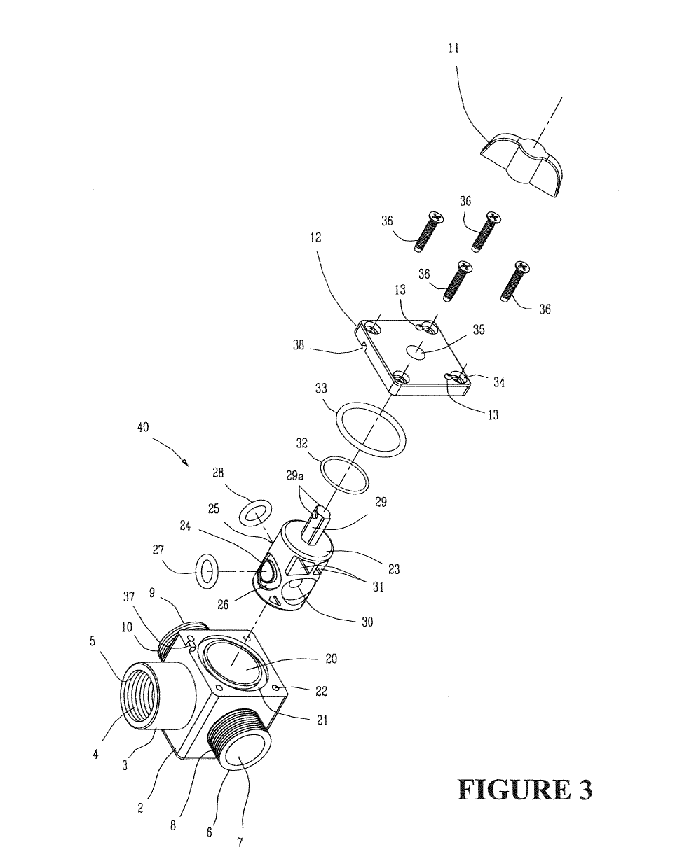

In an embodiment, cover or lid 12 can include one or more hard stops 13 (also illustrated in FIG. 3). Hard stop 13 operates to limit the angular displacement of knob 12 with respect to body 2. That is, hard stop 13 limits how far knob 12 can be turned. In an embodiment, hard stop 13 is embodied in a raised portion of the material forming lid 12. That is, hard stop 13 can be a nub-like protrusion that sticks up from lid 12 with respect to body 2.

In operation, a fluid supply or source is connected to inlet port 3. For example, a water supply source can be connected to inlet port 3 using a threaded connection. First and second outlet ports 6, 9 are each connected to fluid destination paths. A fluid destination path is any path, pipe, hose, device, apparatus or retention system through or into which fluid entering valve 1 can be directed. For example, in accordance with an embodiment of the presently described technology, a fluid destination path can include a showerhead in a traditional shower or bath or an irrigation device. In an embodiment, first outlet port 6 is connected to a showerhead and second outlet port 9 is connected to an irrigation device.

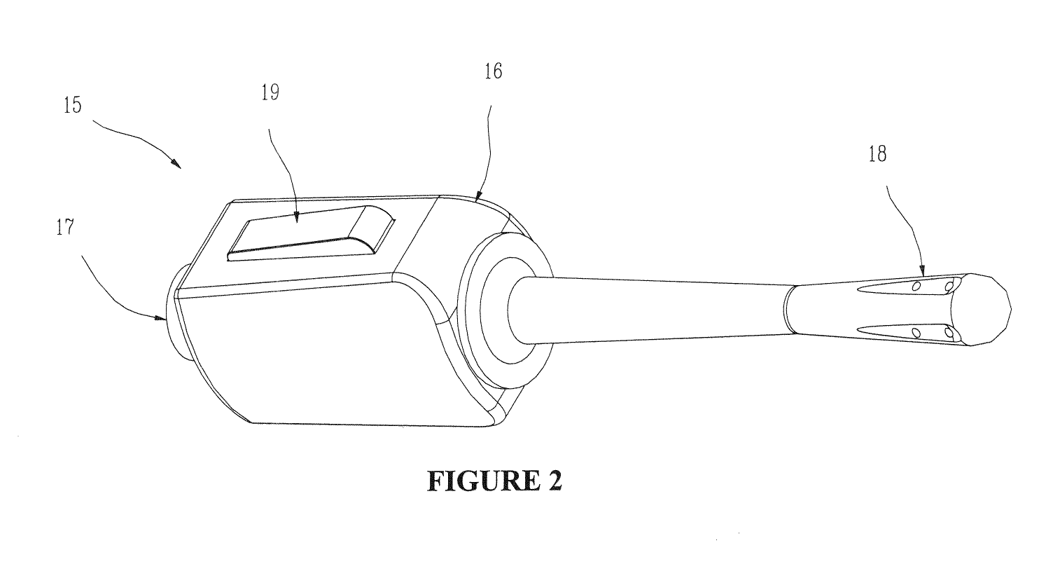

FIG. 2 illustrates a perspective view of an irrigating device 15 capable of being connected to an outlet port 6, 9 of valve 1 in accordance with embodiments of the presently described technology. Irrigating device 15 includes a main body 16, a fluid inlet port 17, a head 18 and a switch 19. In general, irrigating device 15 operates to distribute fluid from one or more orifices in head 18. The fluid enters device 15 via inlet port 17.

Main body 16 of device 15 can include mechanisms and fluid paths to alter the pressure of and/or direction the path of fluid entering irrigating device 15 via inlet port 17 and exiting device 15 via one or more orifices in head 18.

Fluid inlet port 17 can include internal or external threads (similar to internal threads 4 and external threads 8, 10 illustrated in FIG. 1) for providing a more secure connection to outlet port 9. That is, the threads in port 17 can enable a user to screw device 15 onto first or second outlet ports 6, 9 of valve 1. In another embodiment, a flexible pipe or hose (not shown) with threads on one or more ends can also be screwed onto device 15 via the internal or external threads on fluid inlet port 17. The other end of the pipe or hose can also be screwed onto first outlet port 10 of valve 1 in a similar manner, for example.

Head 18 can comprise one or more orifices to direct the output of fluid from device 15. For example, head 18 can be embodied in a water jet head that distributes water from device 15.

Switch 19 comprises any apparatus or device capable of starting or stopping the flow of fluid from inlet port 17 to head 18. For example, switch 19 can be a button that causes a valve or gate inside device 15 to open or close and thus allow or impede the flow of fluid from inlet port 17 to head 18. In this way, switch 19 can function as an on/off switch for device 15.

FIG. 3 illustrates an exploded view of a pressure relief mechanism 40 of valve 1 in accordance with embodiments of the presently described technology. As shown in FIG. 3, pressure relief mechanism 40 includes a cylindrical chamber 20, a spool 23 and a shaft or rod 29.

In an embodiment, spool 23 and/or shaft 29 can each comprise a metallic or plastic material. In an embodiment, spool 23 and/or shaft 29 comprises the same material as body 2. In another embodiment, spool 23 spool 23 and/or shaft 29 comprises a different material as body 2.

Cylindrical chamber 20 is a cylinder-shaped chamber within body 2 of valve 1. In an embodiment, a diameter of chamber 20 is the same as a diameter of spool 23, with allowances for manufacturing tolerances, such as machining tolerances. Chamber 20 can be machined or cut from body 2 of valve 1 during one or more manufacturing processes used to create body 2.

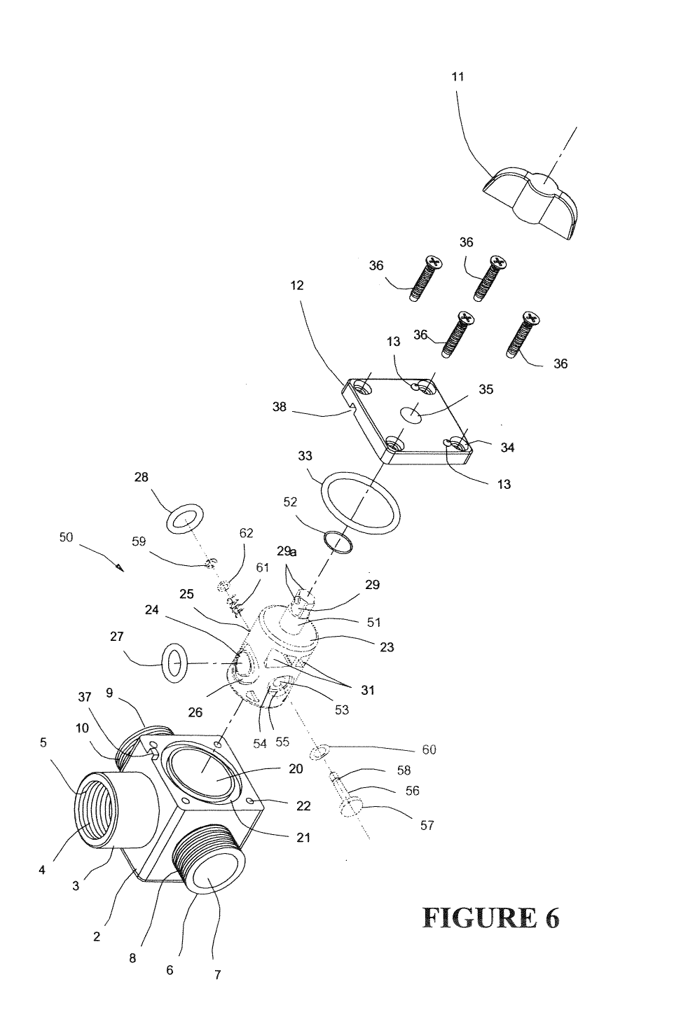

Spool 23 includes at least two openings or orifices 24, 25 and an indentation 30. In an embodiment of the presently described technology, orifices 24, 25 are disposed at right angles with respect to one another, as illustrated in the embodiment shown in FIG. 6. Orifices 24, 25 define and provide a fluid communication channel that meets at the center of spool 23. This channel can direct fluid entering valve 1 to exit via one of outlet ports 6, 9, depending on the orientation of the channel with respect to inlet port 3 and outlet ports 6, 9.

For example, fluid can enter valve 1 via inlet port 3. Fluid can travel from inlet port 3 into spool 23 via orifice 24. Fluid can then be directed along a right angle from orifice 24 to orifice 25. In a first orientation of the fluid communication channel, orifice 24 is aligned with inlet port 3 and orifice 25 is aligned with outlet port 9. When in this orientation, fluid enters valve 1 via inlet port 3 and exits valve 1 via outlet port 9. In a second orientation of the fluid communication channel, orifice 25 is aligned with inlet port 3 and orifice 24 is aligned with outlet port 6. When in this orientation, fluid enters valve 1 via inlet port 3 and exits valve 1 via outlet port 6.

In embodiments of the presently described technology, spool 23 can include one or more recesses 26 that each surrounds one or more of orifices 24, 25. For example, a circular recess 26 can surround each of orifices 24, 25 and accommodate a sealing element 27, 28, respectively. A combination of recess 26 and sealing element 27 or 28 for one or more of orifices 24, 25 can provide a seal for one or more of orifices 24, 25.

Shaft 29 is provided so as to have a common longitudinal axis with spool 23. For example, as shown in FIG. 3, shaft 29 can be disposed on top of spool 23. In an embodiment, shaft 29 is fixed to spool 23 using any of several method of attachment such as adhesive, screws, or nails. In another embodiment, shaft 29 is integrally formed with spool 23. That is, shaft 29 is a part of spool 23 and is incapable of being removed from spool 23.

Shaft 29 is configured to be operatively connected to knob 11. That is, when knob 11 is turned as described above, shaft 29 also turns in a similar direction. As a result, when shaft 29 turns, spool 23 also turns. In this manner, knob 11 can be turned by a user to alter the fluid communication channel described above. That is, when knob 11 is in a first position, the first fluid communication path (described above) exists to direct fluid entering valve 1 from inlet port 3 to outlet port 9. When knob 11 is displaced or turned to a second position (that being a given angular displacement from the first position), the second fluid communication path (also described above) exists to direct fluid entering valve 1 from inlet port 3 to outlet port 6.

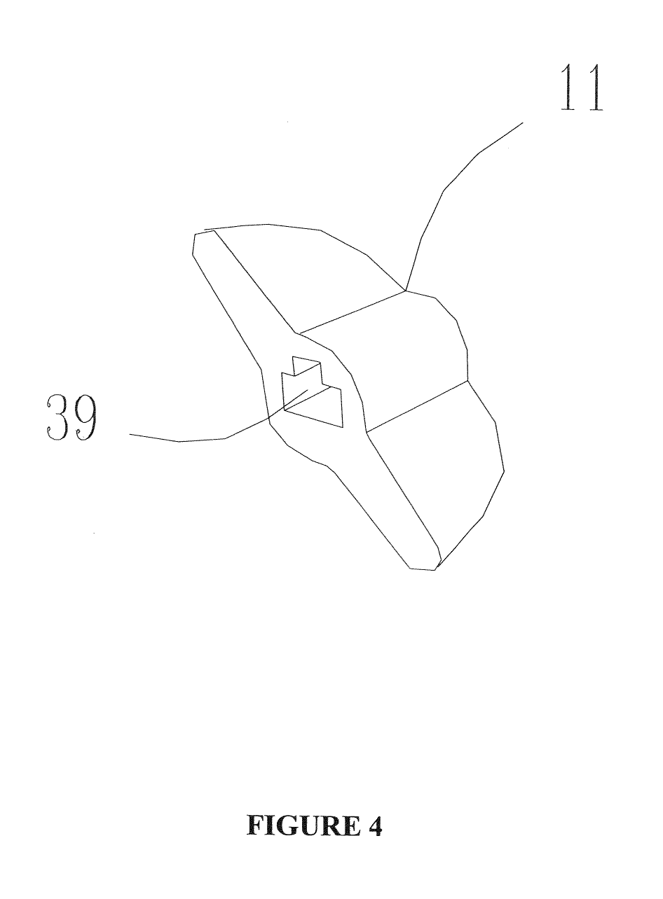

Shaft 29 can be operatively connected to knob 11 in many ways. For example, shaft 29 can be bonded to knob 11 using adhesives or connected to knob 11 using a screw, nail, clamp or other mechanical connection. In an embodiment, shaft 29 is not bonded or otherwise fixed to knob 11. Instead, in this embodiment shaft 29 includes one or more elements 29a to position shaft 29 inside knob 11. For example, elements 29a can include a protrusion that sticks out from the body of shaft 29, as shown in FIG. 3. Knob 11 can then include a hole that is cut or the same shape as a cross-section of shaft 29 with element(s) 29a. FIG. 4 illustrates a perspective view of knob 11 in accordance with embodiments of the presently described technology. As shown in FIG. 4, in this embodiment knob 11 includes a hole 39. Hole 39 is configured to match a shape of shaft 29 and elements 29a. That is, a cross-sectional area of hole 39 is designed to match a cross-sectional area of shaft 29 and elements 29a. In such an embodiment, the match of hole 39 to shaft 29 and elements 29a enables a user to rotate knob 11 in order to cause shaft 29 and spool 23 to rotate.

In an embodiment, elements 29a are asymmetrically disposed on shaft 29 so there is a fixed relative position between knob 11 and shaft 29 when they engage.

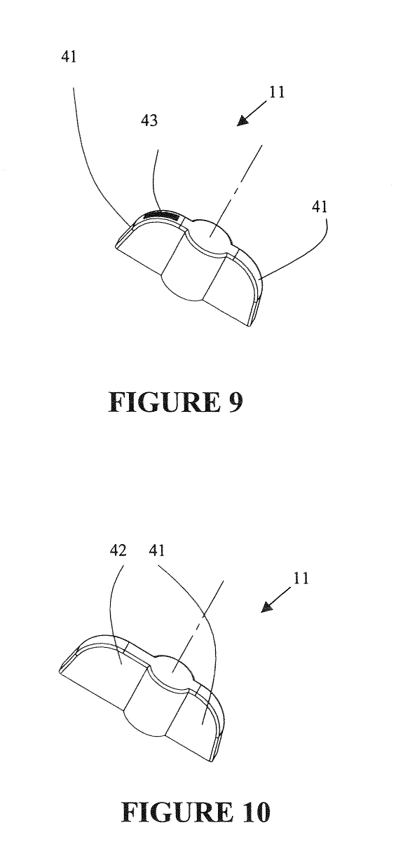

In an embodiment, knob 11 can have symmetrical outlooks or configurations useful for turning knob 11, or asymmetrical external configurations or outlooks. In addition, one or more of the outlooks of knob 11 can include a mark. FIGS. 9 and 10 illustrate perspective views of knob 11 in accordance with embodiments of the presently described technology. As shown in FIGS. 9 and 10, knob 11 can have two or more outlooks or configurations 41, 42. These outlooks 41 can be symmetrical with respect to one another, as shown by outlooks 41 in FIG. 9. Alternatively, these outlooks 41 can be asymmetrical with respect to one another, as shown by outlooks 41 and 42 in FIG. 10. That is, asymmetrical outlooks 41, 42 can exist where one outlook 41 is larger than another outlook 42. Asymmetrical outlooks 41, 42 mark can be provided to, among other thing, make it easier for a user to turn knob 11. In addition, asymmetrical outlooks 41, 42 can also be useful for notifying a user of which position knob 11 and/or spool 23 is in with respect to main body 2, for example.

In an embodiment, one or more outlooks 41, 42 can include a mark or visual representation 43 as shown in FIG. 9. Such a mark 43 can be useful for notifying a user of which position knob 11 and/or spool 23 is in with respect to main body 2, for example.

In an embodiment of the presently described technology, valve 1 includes a pressure release mechanism as a safety means of preventing or inhibiting explosion of valve 1 and valve body 2 in the event of an increase in fluid pressure in body 2. For example, if the fluid communication path is in the first configuration (described above) and orifice 25 and/or the opening created by outlet port 9 becomes blocked, any continuing input of fluid into valve 1 via inlet port 3 can result in an increase in pressure in body 2 and valve 1. After this pressure reaches the threshold of the material and design of valve 1 and/or body 2 (referred to herein as the “failure threshold”), the valve 1 and/or body 2 can fail and possibly explode. Such an explosion can injure users and/or damage surrounding property.

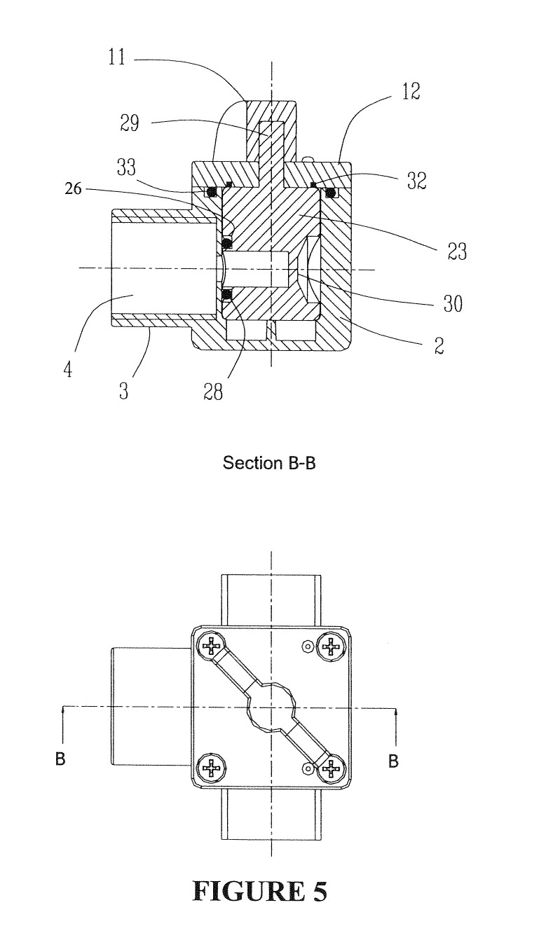

A pressure release mechanism can be embodied in several manners in accordance with the presently described technology. FIGS. 3 and 5 illustrate one embodiment of a pressure release mechanism 40 in accordance with the presently described technology. In such an embodiment, spool 23 includes a thin-walled portion 30. Thin-walled portion 30 of spool 23 is a portion of the wall forming the predominantly cylindrical shape of spool 23 that is thinner than the remainder of the wall, as shown in the Section B-B drawing of FIG. 5. That is, portion 30 of spool 23 is less thick than the remainder of the spool 23 wall. In an embodiment, portion 30 can be created by forming an indentation 30 in spool 23 during manufacturing or machining of spool 23 or at some point in time after the manufacture or machining of spool 23.

The thin walled portion 30 of spool 23 is preferably aligned with outlet port 6 when the first fluid communication channel exists (described above). That is, when fluid enters valve 1 through inlet port 3 and exits via outlet port 9, portion 30 of spool 23 is preferably aligned with outlet port 6. When knob 11 is turned to change the fluid channel from the first to second configuration (described above, where fluid enters valve 1 through inlet port 3 and exits via outlet port 6), portion 30 of spool 23 does not line up with either outlet port 3 or 6.

The local reduction of the thickness of the spool 23 wall introduces a “weak” point for breaking spool 23. In other words, as portion 30 of spool 23 is thinner than the remainder of the cylindrical wall of spool 23, if the fluid pressure inside valve 1 and body 2 becomes too large, portion 30 is more likely to fail than other parts of the spool 23 wall. That is, a thinner wall is more likely to fail under pressure than a thicker wall. When valve 1 is in the first fluid communication channel orientation (described above), fluid normally enters valve 1 through inlet port 3 and exits via outlet port 9. If, through partial or full blockage of outlet port 9 and/or orifice 25, for example, the pressure inside valve 1 and/or body 2 becomes sufficiently large, portion 30 is more likely to fail than the remainder of the spool 23 wall. As portion 30 is aligned with outlet port 6, when portion 30 fails, the fluid can safely exit valve 1 and body 2 via outlet port 6. As the fluid exits valve 1 and body 2, the pressure inside valve 1 and/or body 2 falls or decreases. In this way, any dangerous buildup of hydraulic pressure in valve 1 is released before causing injury or damage to users and surrounding property.

The thickness of portion 30 can be adjusted based on the threshold pressure at which it is desired that portion 30 should break. That is, the thickness of portion 30 can be adjusted so that it fails before any pressure buildup inside valve 1 or body 2 reaches an unsafe level.

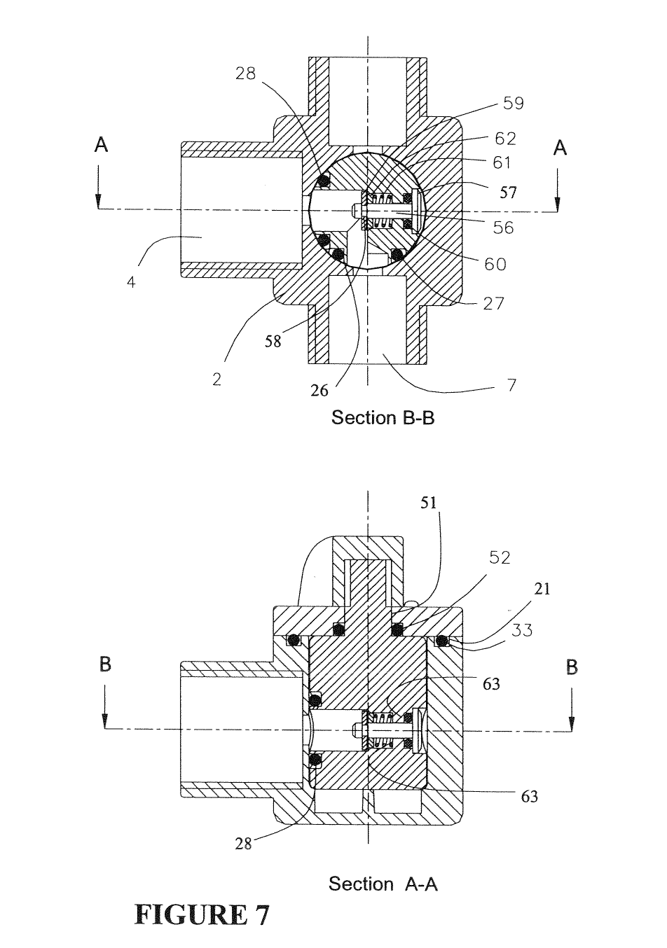

FIGS. 6 and 7 illustrate another embodiment of a pressure release mechanism 50 of valve 1 in accordance with embodiments of the presently described technology. As opposed to the embodiments described above with respect to FIGS. 4 and 5, the embodiments described herein with respect to FIGS. 6 and 7 provide a pressure relief mechanism 50 that is not broken or destroyed during use.

Pressure release mechanism 50 includes a spool 23, a pin 56, a spring 61, a washer 62 and a clip 59. Spool 23 is similar to as described above. However, spool 23 of mechanism 50 includes a hole 53 in place of the thin-walled portion 30 of spool 23 described above. Hole 53 is positioned to be in fluid communication with first fluid communication path (described above). In other words, hole 53 is positioned such that, without any blockage in hole 53, fluid entering valve 1 is capable of flowing in from inlet port 3 and out through first and second outlet ports 6, 9. Within the vicinity of hole 53, spool 23 of mechanism 50 includes an opening 54 and a groove 55.

The portion of spool 23 that includes hole 53 also includes an opening 54 and a circular groove 55. Hole 53, groove 55 and opening 54 form a ledge 63 as shown in FIG. 7.

Pin 56 includes a head portion 57. In an embodiment, head 57 is a flat head for pin 56. Pin 56 is placed inside hole 53. On the end of pin 56 opposite head 57, pin 56 is placed inside washer 62. Clip 59 is placed on the end of pin 56 opposite head 57 and washer 62 so as to hold washer 62 on pin 56. That is, clip 59 is positioned on an end of pin 56 to keep washer 62 on pin 56 between clip 59 and head 57.

In an embodiment, pin 56 includes a groove 58 on the end where clip 59 is to attach. Clip 59 can then sit inside groove 58 to hold washer 62 on pin 56 between clip 59 and head 57. In another embodiment, clip 59 clamps on to the end of pin 56 to hold washer 62 on pin 56 between clip 59 and head 57. That is, as clip 59 clamps onto pin 56, no groove 58 is necessary.

Pin 56 is placed inside hole 53. Spring 61 is placed on pin 56 between washer 62 (attached to the end of pin 56 opposite pin head 57) and ledge 63. In an embodiment, a sealing element 60 can be placed between pin head 57 and ledge 63 on a side of ledge 63 opposite spring 61. Spring 61 is preferably a compression spring.

Spring 61 is placed on pin 56 so as to be under compression. That is, spring 61 is compressed when placed on pin 56 between washer 62 (held in place by clip 59) and ledge 63. As spring 61 is under compression, head 57 of pin 56 is forced towards ledge 63 (and sealing element 60, if used). That is, the mechanism formed by a combination of pin 56, clip 59, spring 61 and washer 62 (and in some embodiments, sealing element 60) causes spring 61 to be compressed and provide a pre-determined load forcing head 57 of pin 56 against ledge 63 (or sealing element 60, if used). In an embodiment, using sealing element 60 can create a water or fluid-tight seal and prevent fluid from passing through hole 53. In this mariner, pin 56 effectively becomes a moveable part of spool 23 wall.

During operation, knob 11 is turned so as to establish or provide the first fluid communication path from intake port 3 through spool 23 and out via outlet port 9. When fluid is supplied to valve 1 from intake port 3, the spring and pin combination described above prevents the fluid from passing through outlet port 6. That is, pin head 57 seals off outlet port 6 so that only outlet port 9 is available for the fluid to leave or escape valve 1. However, as fluid pressure in valve 1 or body 2 increases, the force of the fluid or hydraulic pressure against spring 61 increases. That is, while spring 61 exerts a force to keep pin head 57 against ledge 63 (and/or sealing element 60), the fluid/hydraulic pressure exerts a force attempting to move pin head 57 from contacting ledge 63 (and/or sealing element 60). At some point, the fluid/hydraulic pressure in valve 1 becomes large enough to overcome the force exerted by spring 61. In other words, as the pressure in the first fluid communication path builds, the pressure can eventually become greater than the pre-determined loading of spring 61.

At this point, spring 61 is compressed and pin head 57 no longer contacts ledge 63 (and/or sealing element 60) to prevent fluid from passing through hole 53. Once contact between pin head 57 and ledge 63 (and/or sealing element 60) is compromised, the fluid inside valve 1 can escape through outlet port 6 via hole 53. As the fluid escapes valve 1 through hole 53 and port 6, the pressure built up inside valve 1 can decrease.

Once the pressure inside valve 1 has decreased below the predetermined threshold, the force exerted by the fluid pressure inside valve 1 becomes less than the force exerted by spring 61 on pin head 57. At this point, pin head 57 once again becomes pressed against ledge 63 (and/or sealing element 60) and thus prevents fluid from escaping through hole 53 and outlet port 6. In this way, pressure release mechanism 50 is not destroyed or broken when the fluid/hydraulic pressure inside valve 1 becomes too great, unlike pressure relief mechanism 40. In addition, the use of spring 61 permits continuous use of valve with maintaining approximately constant pressure of the fluid exiting valve 1 through outlet port 9. Therefore, when the hydraulic pressure in valve 1 exceeds a preset safety value, the pressure release mechanism can direct the pressurized fluid to the path of outlet port 6 which should typically, if not always, be in an open position. Accordingly, embodiments of this technology provide a non-destructive pressure relief mechanism that helps to maintain the pressure in valve 1 at a safe and consistent level, thereby protecting users from being injured by dangerously large pressures.

In an embodiment of the presently described technology, body 2 of valve 1 includes a protrusion 37. Protrusion 37 is located on a side of body 2 that meets or matches up with cover 12. Protrusion 37 is designed to engage with a matching notch 38 in cover 12. By matching protrusion 37 with notch 38 during assembly of valve 1, the relative positions of body 2 and cover 12 remain constant and fixed.

Embodiments of the presently described technology can also include one or more sealing elements to increase the sealing capacity of valve 1. For example, at the exit or outlet point of one or more orifices 24, 25 of spool 23, a sealing element can be provided. Specifically, with respect to FIG. 3, on the circumferential surface of spool 23 and at an opening of one or more orifices 24, 25, a circular recess 26 can be provided (not shown with respect to orifice 25, but disposed in a manner substantially identical to orifice 24). These circular recesses 26 are designed to accommodate sealing elements 27, 28.

In another example, a sealing element 32 can be disposed in a circular recess on an inner face of cover 12. The circular recess can be of the same diameter and width as element 32 as shown in FIG. 5, and centered on the central axis to valve 1. Element 32 can help to provide an improved seal between spool 23 and cover 12.

In another example, a sealing element 33 can be disposed in a circular recess 21 surrounding chamber 20 in body 2. Element 33 can help to provide an improved seal between body 2 and cover 12.

In yet another example, spools 23, 50 can include an additional cylindrical portion 51. While this cylindrical portion 51 is only shown in FIG. 6 with respect to pressure release mechanism 50, cylindrical portion 51 can be used with spool 23 of pressure release mechanism 40 in a substantially identical manner.

Cylindrical portion 51 can be connected to spool 23 through any of several techniques. For example, cylindrical portion 51 can be connected using one or more screws, nails, clamps or adhesives. In another example, cylindrical portion 51 can be connected through a snap-fit connection between cylindrical portion 51 and spool 23. In another embodiment, cylindrical portion 51 is integrally formed with spool 23. That is, cylindrical portion 51 is a part of spool 23 and is incapable of being removed from spool 23. A sealing element 52 can be placed around cylindrical portion 51 so as to provide an improved seal between shaft 29 and cover 12, as shown in FIGS. 6 and 7.

In an embodiment, sealing elements 27, 28, 32, 33, 52, 60 each comprise a resilient material. For example, sealing elements 27, 28, 32, 33, 52, 60 can each comprise a rubber or plastic material that resists deformation.

In another embodiment of the presently described technology, one or more cavities 31 can be formed in spool 23. These cavities 31 can assist in reducing the shrinkage rate in the molding process used to create spool 23. For example, if spool 23 is formed from a plastic material, one or more cavities 31 can help reduce the shrinkage rage of spool 23 during molding.

Cover 12 can be attached to body 2 in any of a number of manners. For example, cover 12 can be connected using one or more screws, nails, clamps or adhesives. In another example, cover 12 can be connected through a snap-fit connection between cover 12 and body 2.

In an embodiment, cover 12 is fastened to body 2 by tapping screws 36 through holes 34 in cover 12 and through holes 22 in body 2.

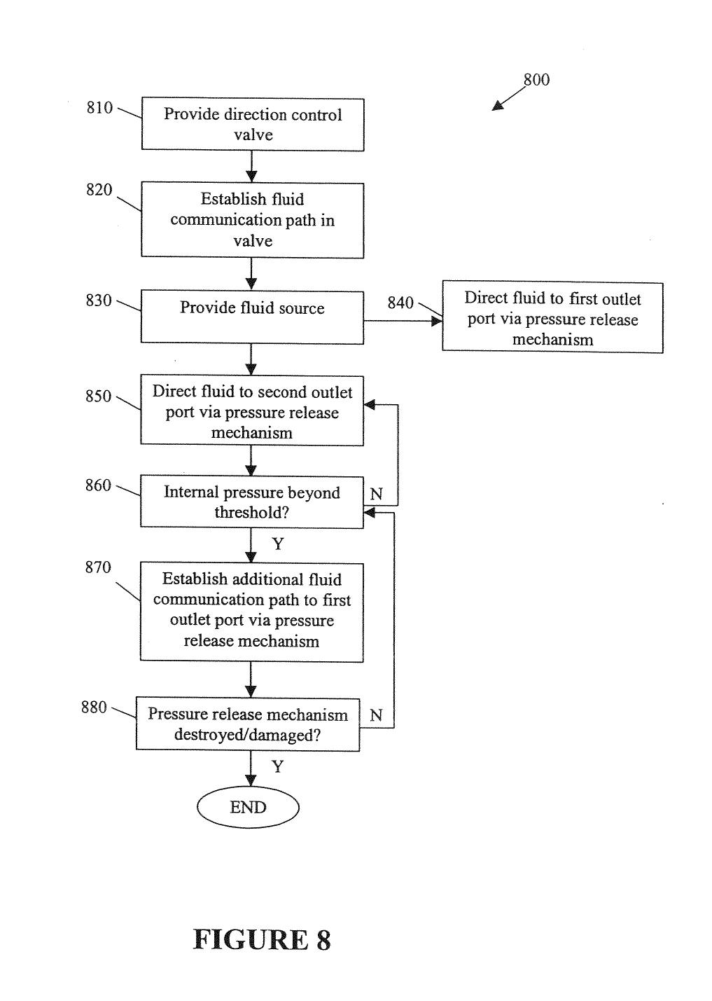

FIG. 8 illustrates a flowchart for a method 800 for providing a pressure release mechanism in a direction control valve in accordance with embodiments of the presently described technology. First, at step 810, a direction control valve is provided. For example, valve 1 as described above can be provided. Next, at step 820, a fluid communication path or channel in valve 1 is established. As described above, the path can be a first communication path from inlet port 3 to second outlet port 9 or a second communication path from inlet port 3 to first outlet port 6.

Following step 820 at step 830, a fluid source is provided to inlet port 3. As described above, the fluid source can be a variety of sources, including a water source, for example.

The next step in method 800 depends on which fluid communication path was established at step 820. If the second fluid communication path was established at step 820, method 800 proceeds from step 830 to step 840. If the first fluid communication path was established at step 820, method 800 proceeds from step 830 to step 850.

At step 840, the fluid coming into valve 1 is directed from inlet port 3 to first outlet port 6 via a pressure release mechanism 40, 50, as described above. For example, the fluid can be directed from inlet port 3 into orifice 25, from orifice 25 through orifice 24 and into opening 7, and from opening 7 out of valve 1 through first outlet port 6. As described above, first outlet port 6 can be connected to, among other things, a showerhead.

At step 850, the fluid coming into valve 1 is directed from inlet port 3 to second outlet port 9 via a pressure release mechanism 40, 50, as described above. For example, the fluid can be directed from inlet port 3 into orifice 24, from orifice 24 through orifice 25 and into the opening created by second outlet port 9, and from this opening out of valve 1 through second outlet port 9. As described above, second outlet port 9 can be connected to, among other things, a water driven device or irrigation device.

Following step 850, at step 860 a determination is made as to whether the internal pressure in valve 1 exceeds a threshold. As described above, the fluid pressure inside valve 1 can increase due to a partial or complete blockage of the first fluid communication path. If the fluid pressure does exceed the threshold, method 800 proceeds from step 860 to step 870. If the fluid pressure does not exceed the threshold, method 800 proceeds from step 860 back to step 850.

At step 870, an additional fluid communication path is established in valve 1 with first outlet port 6 via pressure release mechanism 40, 50. As described above, the various embodiments of the pressure release mechanism 40 can release or reduce pressure in valve 1 by having a thin walled portion 30 of spool 23 rupture or break to establish the additional fluid communication path with first outlet port 6. Alternatively, embodiments of the pressure release mechanism 50 can release or reduce pressure in valve 1 by causing a spring 61 and pin head 57 combination (that normally forms a complete or partial seal) open to release some of the fluid pressure from valve 1 through first outlet port 6, as described above.

Next, at step 880, a determination is made as to whether the pressure release mechanism used in step 870 to release or decrease some or all of the built-up pressure in valve 1 has been damaged or destroyed. If the pressure release mechanism has been damaged or destroyed (by, for example, rupture of thin-walled portion 30 of spool 23 or by some other damage to mechanism 40 or 50), method 800 ends after step 880. If the pressure release mechanism has not been damaged or destroyed, mc1hod 800 proceeds from step 880 to step 860. In another embodiment of the presently described technology, at step 830 one or more of an irrigation device 15 (or other water-driven device) and a showerhead also are provided to second and first outlet ports 9, 6, respectively.

As described herein, embodiments of the presently described technology provide a valve capable of controlling the direction of the flow of fluid through the valve. The valve can be used to control the flow of fluid from a source to one of two destinations such as an irrigation device and a showerhead.

In addition, embodiments of the presently described technology provide a hydraulic direction-control valve with the ability to direct flow of a fluid such as water from an inlet port to various outlet ports combined with a sealing capacity to ensure an increased operation efficiency of any device driven by the pressure of the fluid directed by the valve.

Embodiments of the presently described technology also provide several safety mechanisms to relieve or release hydraulic pressure built up in the valve. These safety mechanisms can help to prevent explosion of the valve and valve body in the event that a flow path of fluid becomes blocked.

While particular elements, embodiments and applications of the presently described invention have been shown and described, it is understood that the presently described invention is not limited thereto since modifications may be made by those skilled in the technology, particularly in light of the foregoing teaching. It is therefore contemplated by the appended claims to cover such modifications and incorporate those features that come within the spirit and scope of the presently described invention.

1. A direction control valve comprising:
a valve body defining a chamber and a first inlet port in selective fluid flow communication with a first outlet port and a second outlet port;
a pressure release mechanism disposed inside the chamber, the pressure release mechanism defining a first orifice and a second orifice for providing a path of fluid through the valve body from the first inlet port to the first outlet port, the pressure release mechanism being configured to reduce pressure in the valve body through the second outlet port, wherein said pressure release mechanism comprises a wall with a moveable portion, said moveable portion configured to impede a flow of fluid from said inlet port to said second outlet port when said pressure is less than a predetermined threshold and permit said flow of fluid from said inlet port to said second outlet port when said pressure exceeds said predetermined threshold.

2. (canceled)

3. (canceled)

4. The valve of claim 1, further including a spring providing resistance to said moveable portion against said pressure.

5. The valve of claim 1, wherein said pressure release mechanism comprises a cylindrical column capable of being rotated to provide said path of fluid flow through said valve from said inlet port to said first outlet port and to provide a second path of fluid flow through said valve from said inlet port to said second outlet port.

6. The valve of claim 5, further including a shaft connected to said cylindrical column, said shaft including one or more elements asymmetrically disposed on said shaft and configured to engage with a knob, wherein said cylindrical column is capable of being rotated by rotating said knob.

7. The valve of claim 5, further including a knob operatively connected to said cylindrical column, said knob including a plurality of outlooks useful for turning said knob, wherein a plurality of said outlooks are asymmetrical with respect to one another.

8. The valve of claim 1, wherein said first outlet port is capable of being connected to an irrigating device, said inlet port is capable of being connected to a fluid source and said second outlet port is capable of being connected to a showerhead.

9. A direction control valve including:
a valve body defining a chamber and a first inlet port in selective fluid flow communication with a first outlet port and a second outlet port;
a pressure release mechanism disposed inside the chamber, the pressure release mechanism defining a first orifice and a second orifice for establishing either a first fluid communication path through the valve body from the first inlet port to the first outlet port or a second fluid communication path through the valve body from the first inlet port to the second outlet port, wherein the second fluid communication path does not exist until an internal pressure inside the valve body exceeds a predetermined threshold, and wherein the pressure release mechanism comprises a spring that impedes fluid from moving along the second fluid communication path when the internal pressure is less than the threshold and permits the fluid from moving along the second fluid communication path when the internal pressure exceeds said threshold.

10. (canceled)

11. (canceled)

12. (canceled)

13. (canceled)

14. (canceled)

15. The valve of claim 9, wherein said spring is a compression spring that pushes a head of a pin against a sealing element to impede said fluid from moving along said second fluid communication path when said internal pressure is less than said threshold.

16. The valve of claim 9, wherein each of said first and second orifices are surrounded by a sealing element.

17. A method for releasing pressure in a direction control valve, said method including:
providing a valve body defining a chamber and a first inlet port in selective fluid flow communication with a first outlet port and a second outlet port and a pressure release mechanism having a wall with a moveable portion; and
reducing pressure in the valve body through the second outlet port by moving the moveable portion of the wall in the valve body.

18. The method of claim 17, further including the moveable portion of the wall impeding a flow of fluid from said inlet port to said second outlet port when said pressure in said valve body is less than a predetermined threshold, wherein said reducing step includes permitting said flow of fluid from said inlet port to said second outlet port when said pressure exceeds said predetermined threshold.

19. The method of claim 17, further including connecting said first outlet port to an irrigating device, said inlet port to a fluid source and said second outlet port to a showerhead.

20. The method of claim 17, wherein said first and second orifices are perpendicular to each other.
